(19) United States
(12) Patent Application Publication
(10) Pub. No.: US 2026/0066523 A1
(43) Pub. Date: Mar. 5, 2026

(54) PACKAGING STRUCTURE AND MANUFACTURING METHOD THEREOF

(71) Applicant: Industrial Technology Research Institute, Hsinchu (TW)

(72) Inventors: Ching-Wen Chiang, Hsinchu City (TW); Huan-Ta Chen, Hsinchu County (TW); Yu-An Chang, New Taipei City (TW)

(73) Assignee: Industrial Technology Research Institute, Hsinchu (TW)

(21) Appl. No.: 18/919,473

(22) Filed: Oct. 18, 2024

(30) Foreign Application Priority Data
Aug. 30, 2024 (TW) 113132805

(51) Int. Cl. H01Q 1/22; H01L 23/31; H01L 23/538; H01L 23/552; H01L 25/00; H01L 25/03; H01Q 1/42; H01Q 1/48

(52) U.S. Cl. CPC H01Q 1/2283; H01Q 1/42; H01Q 1/48

(57) ABSTRACT

A packaging structure and a manufacturing method thereof are provided. The packaging structure includes a substrate, a plurality of antenna module assembly, a first encapsulant layer, a superstrate, and a radome. The plurality of antenna module assembly is arranged in an array over the substrate. The first encapsulant layer is disposed on the array of antenna module assemblies and encapsulates each of the array of antenna module assemblies. The superstrate is disposed on the first encapsulant layer. An orthographic projection area of the superstrate on the substrate is larger than an orthographic projection area of each of plurality of antenna module assembly on the substrate. The radome is disposed on the superstrate.

### CROSS-REFERENCE TO RELATED APPLICATION

This application claims the priority benefit of Taiwan Patent Application No. 113132805, filed on Aug. 30, 2024. The entirety of the above-mentioned patent application is hereby incorporated by reference herein and made a part of this specification.

### BACKGROUND

### 1. Field of the Invention

The technical field relates to a structure and its manufacturing method, including a packaging structure and its manufacturing method.

### 2. Description of Related Art

As global communication demands surge, Low Earth Orbit (LEO) satellite communication systems, with their wide coverage and low latency, have become pivotal in next-generation communication technologies. These satellites typically operate in low Earth orbits ranging from 300 to 2,000 kilometres and move at high speeds relative to the Earth's surface, requiring ground user terminals to continuously track the satellites to ensure communication link stability.

Traditional mechanical scanning antenna systems rely on the physical movement of antennas to adjust beam direction. Although these systems provide high precision, they are slower in response time and require larger system sizes and higher power consumption. In contrast, Active Electronically Scanned Array (AESA) antennas electronically adjust beam direction without mechanical movement, resulting in faster response times and enhanced accuracy. However, AESA technology necessitates rapid beam switching and precise tracking within milliseconds. Furthermore, manufacturing and maintenance costs, particularly in high-frequency millimeter-wave bands, present significant challenges.

To facilitate the use of high-frequency millimeter-wave and sub-terahertz (sub-THz) bands in next-generation Low Earth Orbit (LEO) communication systems, including the Ku band (12-18 GHz), Ka band (26-40 GHz), and E band (71-86 GHz), these frequency bands provide considerable bandwidth, supporting higher data rates and lower latency. However, as frequencies increase, systems encounter challenges such as signal attenuation and the need for high-performance antenna designs. In response to these challenges, advanced antenna packaging and material selection are required to maintain stable communication performance in LEO ground communication equipment, particularly in addressing the effects of signal attenuation inherent in high-frequency operations.

### SUMMARY OF THE INVENTION

The present disclosure relates to a packaging structure that includes a substrate, an array of antenna module assemblies, a first encapsulation layer, a superstrate, and a radome. The array of antenna module assemblies are arranged on the substrate, and the first encapsulation layer encapsulates each module. The superstrate is positioned over the first encapsulation layer, with its projected area on the substrate being larger than that of each antenna module assembly. A radome is positioned above the superstrate.

Additionally, the present disclosure provides a method for manufacturing an embodiment of the packaging structure, which involves the following steps. An array of antenna module assemblies are mounted on the substrate. A first encapsulation layer is formed over these modules to encapsulate each one. A superstrate is then formed over the first encapsulation layer, where the projected area of the superstrate is larger than that of each antenna module assembly. Lastly, a radome is formed over the superstrate.

In some embodiments, a packaging structure may be formed by an array of small-area antenna module assemblies on a large-area substrate. The array of antenna module assemblies may be selected or configured according to specific requirements, allowing for flexible manufacturing processes that accommodate packaging structures supporting a plurality of frequency bands.

### BRIEF DESCRIPTION OF THE DRAWINGS

The accompanying drawings are provided to enhance the understanding of the disclosure and are incorporated as part of the specification. These drawings illustrate various embodiments and, together with the description, explain the principles of the disclosure.

FIG. 1A is a cross-sectional schematic of a packaging structure in accordance with one embodiment.

FIG. 1B is a cross-sectional schematic of an antenna array module in accordance with one embodiment.

FIG. 1C is a top view of an antenna array module in accordance with one embodiment.

FIG. 1D is a top view of an antenna array module in accordance with another embodiment.

FIG. 1E is a top view of an antenna array module in accordance with another embodiment.

FIG. 2A is a cross-sectional schematic of a packaging structure in accordance with another embodiment.

FIG. 2B is a partial top view of the packaging structure shown in FIG. 2A.

FIGS. 2C-2E are top views of repeating patterns in accordance with various embodiments.

FIG. 3 is a cross-sectional schematic of a packaging structure in accordance with another embodiment.

FIG. 4 is a cross-sectional schematic of a packaging structure in accordance with another embodiment.

FIGS. 5A-5B, 6, 7, and 8 are schematic views illustrating a manufacturing process of an antenna structure in accordance with one embodiment.

FIGS. 9-11 are cross-sectional schematics illustrating a manufacturing process of a packaging structure in accordance with one embodiment.

### DESCRIPTION OF THE EMBODIMENTS

In Low Earth Orbit (LEO) ground communication equipment, millimeter-wave technology leads to the attenuation of millimeter-wave signals due to the high-frequency band characteristics. The present invention provides embodiments of high-gain antenna designs, multiple-input multiple-output (MIMO) technology, and designs of packaging materials and radomes.

High-gain antenna design is a compensatory technology provided when millimeter-wave signals attenuate in high-frequency bands. For example, phased array antennas improve the directivity and strength of signals through beamforming, ensuring the signal can effectively penetrate the atmosphere and maintain a stable communication link.

Multiple Input Multiple Output (MIMO) technology uses multiple antenna elements in the millimeter-wave frequency band to simultaneously transmit and receive multiple signal channels, greatly improving spectral efficiency and data throughput, thereby enhancing the reliability and data transmission rates of LEO satellite communications.

The design of packaging materials and radomes provides low-loss and high-transmission materials to effectively withstand harsh weather conditions, ensuring long-term durability and stability of the antenna system.

In addition, the present invention integrates the superstrate and radome into the antenna packaging structure, which helps to enhance signal gain and directivity, while also providing effective environmental protection to ensure long-term stable operation of the antenna in harsh conditions. This means that the present invention optimizes the electrical performance of the antenna through the design of the superstrate and utilizes the radome to resist external environmental influences, thereby enabling the transmission of millimeter-wave signals in high-frequency millimeter-wave communications.

In this embodiment, the superstrate is mainly used to enhance the electrical performance of the antenna, such as gain and directivity, while the radome primarily protects the antenna from external environmental influences. Therefore, combining these two structures requires precise design and material selection to avoid increased signal loss due to material mismatch. When the materials are mismatched, the radome may hinder effective heat dissipation, causing system overheating, which affects its stability and performance. Additionally, millimeter-wave signals may further attenuate when passing through the radome. To address this, the present invention adopts a large-area antenna array to ensure that millimeter-wave signals can effectively transmit within the atmosphere.

In this embodiment, the antenna packaging structure can employ a large-area antenna array. However, due to the uneven distribution of metal density between the large-area antenna array and the active circuit layer, warpage occurs. To address this, the present invention selects materials with a low coefficient of thermal expansion, low modulus, high flowability, and low dielectric loss to reduce warpage of the large-area antenna array. Additionally, in this embodiment, the large-area antenna array is cut into smaller, side-by-side subarrays, such as basic arrays of 4×4 or 8×8, to further reduce warpage. Detailed content will be described later.

In this embodiment, an encapsulation layer is filled between adjacent subarrays to reduce the warpage of the subarrays. Encapsulation layer 120 may be formed of dielectric materials such as polyimide, benzocyclobutene (BCB), or silicone-based compounds, each exhibiting low dielectric loss and high heat resistance, particularly suitable for high-frequency millimeter-wave applications.

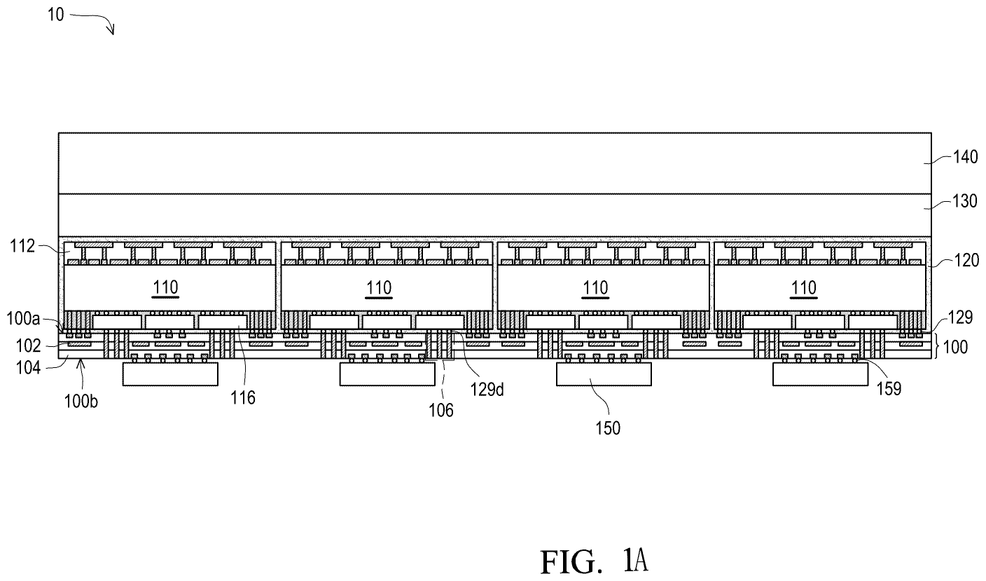

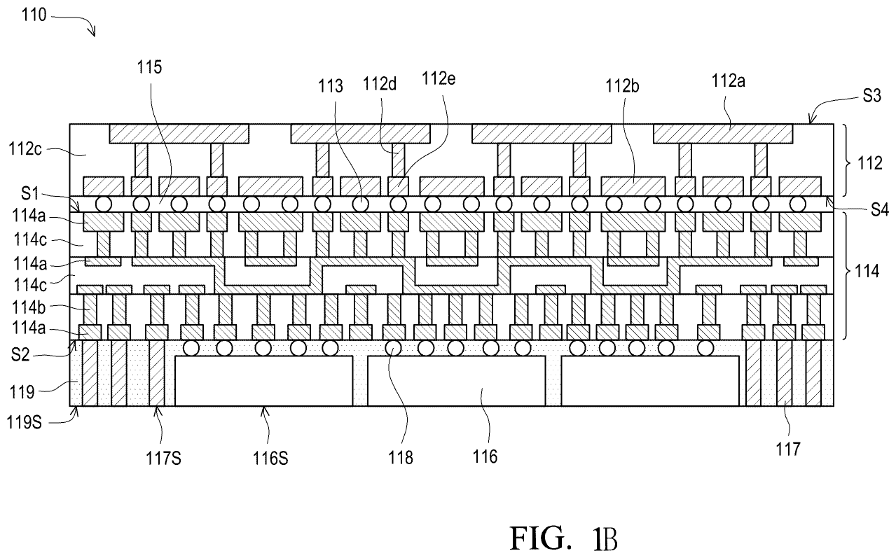

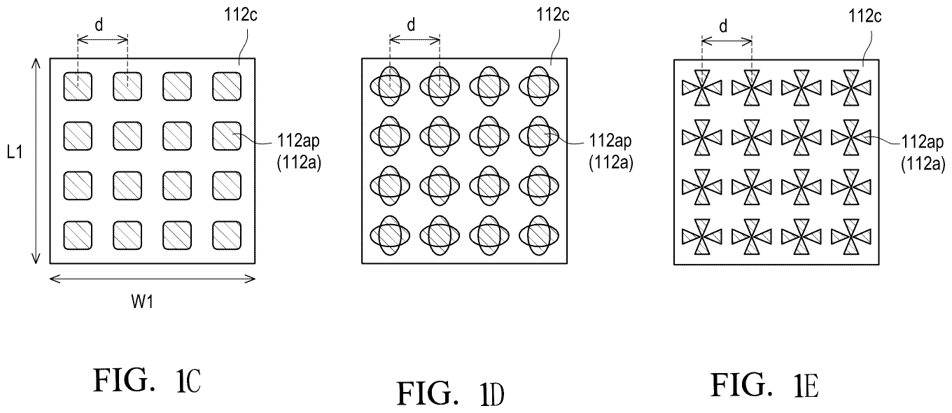

FIG. 1A is a cross-sectional schematic diagram of a packaging structure according to an embodiment of the present invention. FIG. 1B is a cross-sectional schematic diagram of an antenna array module according to an embodiment of the present invention. FIG. 1C is a top view schematic diagram of an antenna array module according to an embodiment of the present invention. FIG. 1D is a top view schematic diagram of an antenna array module according to another embodiment of the present invention. FIG. 1E is a top view schematic diagram of an antenna array module according to another embodiment of the present invention. For clarity, details of the antenna array module 110 are simplified in FIG. 1A, while FIG. 1B can be regarded as an enlarged schematic diagram of the antenna array module 110 in FIG. 1A.

Please refer to FIG. 1A. The packaging structure 10 includes a substrate 100, an array of antenna module assemblies 110, a first encapsulation layer 120, a superstrate 130, and a radome 140. The array of antenna module assemblies 110 includes a plurality of antenna array modules, the plurality of antenna array modules 110 are arranged in an array on the upper surface 100a of the substrate 100. The first encapsulation layer 120 is disposed on the plurality of antenna array modules 110 and encapsulates each of the array of antenna module assemblies 110. The superstrate 130 is disposed on the first encapsulation layer 120, and the projected area of the superstrate 130 on the substrate 100 is larger than the projected area of each of the array of antenna module assemblies 110 on the substrate 100. The radome 140 is disposed on the superstrate 130.

The substrate 100 may include multiple conductive layers 102 and insulating layers 104 stacked alternately. The conductive layers 102 may include wiring portions and through-hole portions to provide electrical connections in horizontal and vertical directions. In some embodiments, the substrate 100 may also include heat dissipation structures 106, disposed within the insulating layer 104 of the substrate 100. The heat dissipation structures 106 may include heat dissipation pillars, heat dissipation plates, or other suitable heat dissipation structures. The present invention is not limited to these examples. For example, in FIG. 1A, the heat dissipation structures 106 is a heat dissipation pillar passing through multiple stacked insulating layers 104 of the substrate 100. In some embodiments, the substrate 100 may be a printed circuit board, motherboard, or other suitable circuit board. In some embodiments, the length and/or width of the substrate 100 may be between 40 mm and 300 mm.

In some embodiments, the antenna array module 110 may include an antenna structure 112, a circuit structure 114, and a first chip 116, as shown in FIG. 1B. The circuit structure 114 has a first surface S1 and a second surface S2 opposite the first surface S1. The antenna structure 112 is disposed on the first surface S1 of the circuit structure 114, and the first chip 116 is disposed on the second surface S2 of the circuit structure 114. The second surface S2 of the circuit structure 114 faces the substrate 100, such that the first chip 116 is located between the antenna structure 112 and the substrate 100.

In some embodiments, the circuit structure 114 may include wiring layers 114a located in insulating layers 114c and via holes 114b. The via holes 114b are disposed between adjacent wiring layers 114a in the vertical direction, enabling electrical connection between vertically adjacent wiring layers 114a through the via holes 114b. In some embodiments, the insulating layers 114c may include dielectric materials with a dielectric constant between 2 and 5. In some embodiments, the insulating layers 114c may include fiberglass, ceramics, glass, or other suitable materials. The present invention is not limited to these materials. In some embodiments, the materials of the wiring layers 114a and the via holes 114b may include copper, gold, silver, iron, tin, nickel, alloys thereof, combinations thereof, or other suitable conductive materials. The present invention is not limited to these materials.

In some embodiments, the antenna structure 112 may include an antenna layer 112a, a ground layer 112b, and a dielectric layer 112c. The dielectric layer 112c has a third surface S3 and a fourth surface S4 opposite the third surface S3. The fourth surface S4 of the dielectric layer 112c faces the first surface S1 of the circuit structure 114. The antenna layer 112a is disposed on the third surface S3 of the dielectric layer 112c, and the ground layer 112b is disposed on the fourth surface S4 of the dielectric layer 112c.

In some embodiments, the antenna layer 112a may include a plurality of antenna patterns 112ap arranged in an array, as shown in FIGS. 1C to 1E. In some embodiments, the antenna layer 112a includes antenna patterns 112ap arranged in at least 4 rows and 4 columns (i.e., 4×4 antenna patterns 112ap), but the present invention is not limited to this. In other embodiments, the antenna layer 112a may include more rows or columns of antenna patterns 112ap, and the number of rows and columns may differ.

In some embodiments, from a top-down view, the shapes of the antenna patterns 112ap may include rectangular (as shown in FIG. 1C), circular, oval, four-leaf clover (as shown in FIG. 1D), bow-tie, double bow-tie (as shown in FIG. 1E), or other suitable shapes. The present invention is not limited to these shapes.

In some embodiments, the spacing d of the antenna patterns 112ap may be λ/2, where λ is the wavelength of the desired transmitted signal. In this context, the spacing d is defined as the distance between the centers of adjacent antenna patterns 112ap. By designing the shape, spacing, and size of the antenna patterns 112ap, the frequency band supported by the antenna layer 112a can be adjusted. In some embodiments, the antenna layer 112a may be configured to transmit signals with millimeter-wave wavelengths. For example, it may support signals in the K-band (e.g., 15 GHz to 35 GHz), V-band (e.g., 60 GHz), or W-band (e.g., 77 GHz to 94 GHz).

In some embodiments, the length L1 (as indicated in FIG. 1C) and/or width W1 (as indicated in FIG. 1C) of the antenna structure 112 (or antenna array module 110) may be between 10 mm and 30 mm.

In some embodiments, the antenna structure 112 further includes vertical connectors 112d and contact points 112e. The contact points 112e are disposed on the fourth surface S4 of the dielectric layer 112c and are located in the same film layer as the ground layer 112b. The vertical connectors 112d are disposed between the antenna layer 112a and the contact points 112e to transmit signals between the antenna layer 112a and the circuit structure 114.

In some embodiments, the dielectric layer 112c may include dielectric materials with a dielectric constant between 2 and 5. In some embodiments, the dielectric layer 112c may include fiberglass, ceramics, glass, or other suitable materials. The present invention is not limited to these materials. In some embodiments, the materials of the antenna layer 112a, the ground layer 112b, the vertical connectors 112d, and the contact points 112e may include copper, gold, silver, iron, tin, nickel, alloys thereof, combinations thereof, or other suitable conductive materials. The present invention is not limited to these materials.

In some embodiments, the antenna structure 112 may be electrically connected to the wiring layer 114a of the circuit structure 114 through conductive connectors 113. In some embodiments, a filling layer 115 may be disposed between the antenna structure 112 and the circuit structure 114, laterally encapsulating the conductive connectors 113. In some embodiments, the filling layer 115 may include underfill materials, thermal interface materials, or other suitable insulating filling materials. The present invention is not limited to these materials.

In some embodiments, the first chip 116 may include an active chip or a passive chip. An active chip may include a beamformer IC or other similar active chips. A passive chip may include a power divider IC or other suitable passive chips. In some embodiments, the first chip 116 may be electrically connected to the wiring layer 114a of the circuit structure 114 through conductive connectors 118, with the active surface of the first chip 116 facing the circuit structure 114. In some embodiments, a heat dissipation layer (not shown) may be disposed on the backside of the first chip 116 (i.e., the surface opposite to the active surface) to assist with heat dissipation. The heat dissipation material may include thermally conductive silver grease, ceramics (ALNCU), thermal interface materials (TIM), or other suitable thermally conductive materials. The present invention is not limited to these materials. FIG. 1B schematically illustrates an antenna array module 110 including three first chips 116, but this does not limit the invention. The number of first chips 116 may be adjusted based on actual needs.

In some embodiments, the plurality of antenna array modules 110 further include conductive pillars 117 and a second encapsulation layer 119. The second encapsulation layer 119 is disposed on the second surface S2 of the circuit structure 114 and laterally encapsulates at least the first chip 116. The conductive pillars 117 are arranged within and penetrate through the second encapsulation layer 119 to electrically connect with the circuit structure 114. The second encapsulation layer 119 may also fill the gaps between the first chip 116 and the circuit structure 114, as well as the gaps between adjacent first chips 116.

In some embodiments, the second encapsulation layer 119 may not cover the backside of the first chip 116, leaving the backside of the first chip 116 exposed. In some embodiments, the surface 119S of the second encapsulation layer 119 (e.g., the bottom surface of the second encapsulation layer 119 in FIG. 1B) may be substantially coplanar with the surface 117S of the conductive pillars 117 (e.g., the bottom surface of the conductive pillars 117 in FIG. 1B) and the surface 116S of the first chip 116 (e.g., the backside of the first chip 116 in FIG. 1B).

In some embodiments, the second encapsulation layer 119 may include molding compounds, molding underfill, or the like. The present invention is not limited to these materials. In some embodiments, the conductive pillars 117 may be made of materials such as copper, gold, silver, iron, tin, nickel, alloys thereof, combinations thereof, or other suitable conductive materials. The present invention is not limited to these materials.

In some embodiments, the array of antenna module assemblies 110 may be electrically connected to the substrate 100 through conductive connectors 129. For example, the conductive connectors 129 may connect the conductive pillars 117 of the array of antenna module assemblies 110 to the conductive layer 104 of the substrate 100, enabling signal transmission. In some embodiments, some of the conductive connectors 129 may be dummy conductive connectors 129d connected to the heat dissipation structures 106 of the substrate 100, further dissipating the heat from the first chip 116 to the external environment. In some embodiments, the conductive connectors 113 and 129 may include solder balls, solder bumps, or other suitable materials.

In some embodiments, the first encapsulation layer 120 may be positioned within the gap between the array of antenna module assemblies 110 and the substrate 100, laterally encapsulating the conductive connectors 129. Portions of the first encapsulation layer 120 may also be positioned in the gap between adjacent antenna array modules 110. Additionally, portions of the first encapsulation layer 120 may be located between the array of antenna module assemblies 110 and the superstrate 130.

In some embodiments, the first encapsulation layer 120 may include molding compounds, molding underfill, or the like. The present invention is not limited to these materials.

The superstrate 130, covering the array of antenna module assemblies 110, effectively improves the matching between the antenna and millimeter-wave signals, enhancing the antenna's supported bandwidth. In some embodiments, the superstrate 130 may include dielectric materials with a dielectric constant between 2 and 10. The superstrate 130 may also include molding compounds, benzocyclobutene (BCB), glass, silicon, ceramics, or other suitable dielectric materials. In some embodiments, the thickness of the superstrate 130 may range from 0.5 mm to 4 mm. Additionally, the projected area of the first encapsulation layer 120 on the substrate 100 may be substantially the same as that of the superstrate 130 on the substrate 100.

The radome 140 covers the entire superstrate 130, protecting the structure beneath it and reducing the likelihood of damage caused by exposure to moisture, dust, or the like. In some embodiments, the radome 140 may include dielectric materials with a dielectric constant between 2 and 10. In some embodiments, the radome 140 may include molding compounds, ABS resin, glass, silicon, ceramics, or other suitable dielectric materials. In some embodiments, the thickness of the radome 140 may range from 0.5 mm to 4 mm. In some embodiments, the thickness of the radome 140 is an integer multiple of the effective half-wavelength, which reduces signal loss due to wave dispersion during transmission.

In some embodiments, the packaging structure 10 further includes a second chip 150 disposed on the bottom surface 100b of the substrate 100, where the bottom surface 100b is opposite to the top surface 100a. In other words, the substrate 100 is located between the first chip 116 and the second chip 150. In some embodiments, the second chip 150 may be an RF chip for receiving or transmitting RF signals. FIG. 1A schematically illustrates four second chips 150, but this is not limiting to the invention, and the number of second chips 150 may be adjusted according to actual needs.

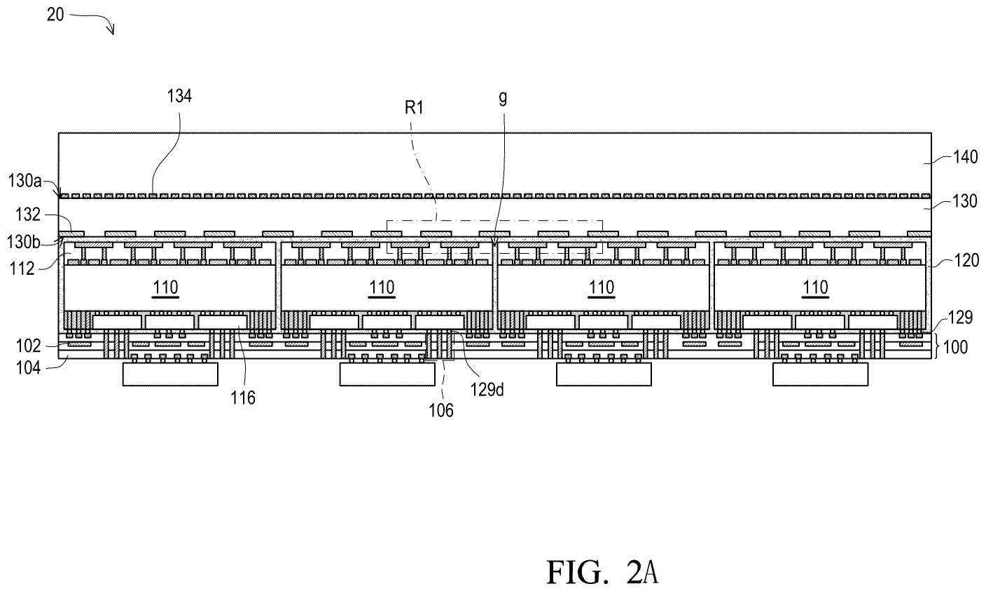

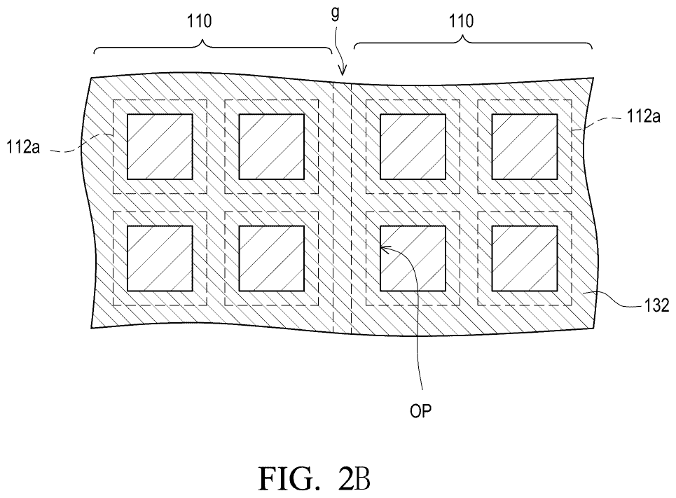

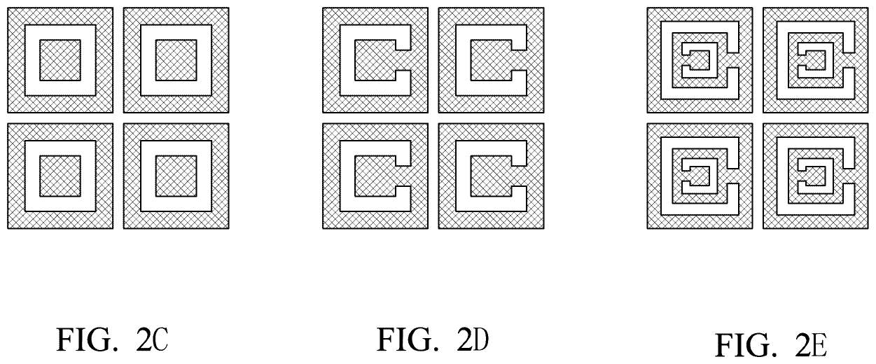

The components and parts of FIGS. 2A to 2E correspond to those of the embodiments shown in FIGS. 1A to 1E, with the same or similar reference numerals representing the same or similar elements, and descriptions of identical technical content are omitted. Descriptions of the omitted portions can be found in the aforementioned embodiments and are not repeated here. For clarity, FIG. 2B shows only the antenna layer 112a and the coupling layer 132, omitting other components (e.g., the dielectric material of the superstrate 130, the encapsulation layer 120, etc.).

Referring to FIG. 2A, the main difference between packaging structure 20 and packaging structure 10 is that the upper surface 130a of the superstrate 130 in packaging structure 20 includes a repeating pattern 134, while the lower surface 130b of the superstrate 130 includes a coupling layer 132. The upper surface 130a of the superstrate 130 is opposite the lower surface 130b, with the lower surface 130b facing the array of antenna module assemblies 110 and the upper surface 130a facing the radome 140. In other words, the coupling layer 132 faces the array of antenna module assemblies 110, and the repeating pattern 134 faces the radome 140.

In some embodiments, from a top view, the pattern of the coupling layer 132 is complementary to the pattern of the antenna layer 112a of the array of antenna module assemblies 110. For example, as shown in FIG. 2B, the antenna layer 112a includes a plurality of rectangular antenna patterns arranged in an array, and the coupling layer 132 includes a plurality of openings OP corresponding to the rectangular antenna patterns, forming a grid-like pattern. In some embodiments, the size of the openings OP (e.g., length and width) may be smaller than the size of the rectangular antenna patterns, meaning the coupling layer 132 may partially overlap with the antenna layer 112a.

In some embodiments, the projection of the coupling layer 132 on the substrate 100 overlaps with the projection of the gap g between adjacent antenna module assemblies 110 on the substrate 100.

In some embodiments, the coupling layer 132 may be made of copper, gold, silver, iron, tin, nickel, their alloys, combinations thereof, or other suitable metal materials, without limiting the scope of the invention.

In some embodiments, FIG. 2B illustrates rectangular antenna patterns as an example, but this is not limiting to the invention, and the antenna patterns may have other shapes as described in the previous embodiments. The coupling layer may then form complementary patterns with openings corresponding to the antenna patterns.

Since the lower surface 130b of the superstrate 130 includes the coupling layer 132, the length of the antenna layer 112a in the packaging structure 10 effectively extends, producing frequency band connectivity, allowing the packaging structure 10 to support a wider range of frequency bands and providing more options.

The repeating pattern 134 may be periodically arranged on the upper surface 130a of the superstrate 130, functioning as a frequency-selective surface, giving the packaging structure 10 good frequency selectivity and/or impedance matching. In some embodiments, from a top view, the shape of the repeating pattern 134 may include rectangular, circular, rectangular with rectangular ring openings (as shown in FIG. 2C), circular with annular openings, rectangular with C-shaped openings (as shown in FIG. 2D) or circular, rectangular with double C-shaped openings (as shown in FIG. 2E) or circular, spiral, or other suitable shapes, without limiting the scope of the invention.

In some embodiments, the repeating pattern 134 may include metamaterials. In some embodiments, the repeating pattern 134 may be made of copper, gold, silver, iron, tin, nickel, their alloys, combinations thereof, or other suitable metal materials, without limiting the scope of the invention.

Although this embodiment illustrates the upper surface 130a and lower surface 130b of the superstrate 130, respectively, including the repeating pattern 134 and coupling layer 132, this is not limiting to the invention. In other embodiments, only the repeating pattern 134 may be disposed on the upper surface 130a of the superstrate 130, or only the coupling layer 132 may be disposed on the lower surface 130b of the superstrate 130.

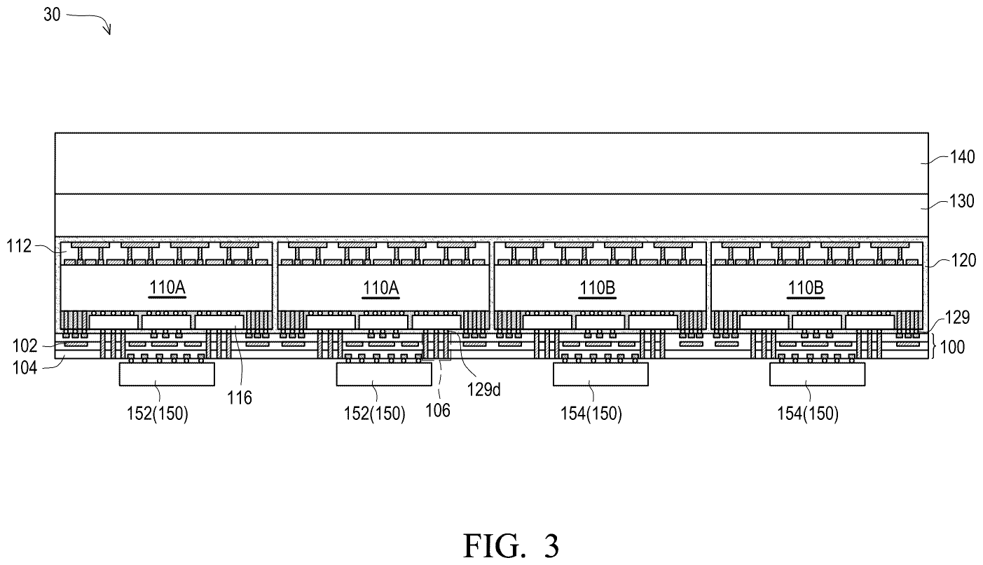

The components and parts in FIG. 3 correspond to those in the embodiments shown in FIGS. 1A to 1E, with the same or similar reference numerals representing the same or similar elements. Descriptions of identical technical content are omitted. For omitted portions, please refer to the previous embodiments, which are not repeated here.

Referring to FIG. 3, the main difference between packaging structure 30 and packaging structure 10 is that packaging structure 30 supports dual-band or multi-band signal transmission. For example, the second chip 150 may include an RF transmission chip 152 and an RF reception chip 154. The signal band transmitted by the RF transmission chip 152 is different from the signal band received by the RF reception chip 154. For example, the signal band transmitted by the RF transmission chip 152 (e.g., 28 GHz) is greater than the signal band received by the RF reception chip 154 (e.g., 18 GHz). To accommodate the different frequency bands of the RF transmission chip 152 and the RF reception chip 154, the array of antenna module assemblies 110 may include a first array of antenna module assemblies 110A and a second array of antenna module assemblies 110B, where the first array of antenna module assemblies 110A is configured to transmit the signal from the RF transmission chip 152, and the second array of antenna module assemblies 110B is configured to receive the signal and transmit it to the RF reception chip 154. Therefore, the frequency band supported by the first array of antenna module assemblies 110A is different from the frequency band supported by the second array of antenna module assemblies 110B.

Since the frequency band supported by the first array of antenna module assemblies 110A is different from the frequency band supported by the second array of antenna module assemblies 110B, the size, shape, arrangement, or spacing of the antenna patterns in the antenna layer 112a of the first array of antenna module assemblies 110A may differ from those in the antenna layer 112a of the second array of antenna module assemblies 110B.

FIG. 3 schematically illustrates two types of second chips and two types of antenna module assembly, but this is not limiting to the invention. The types and quantities of the second chips and antenna module assembly may be adjusted according to actual needs.

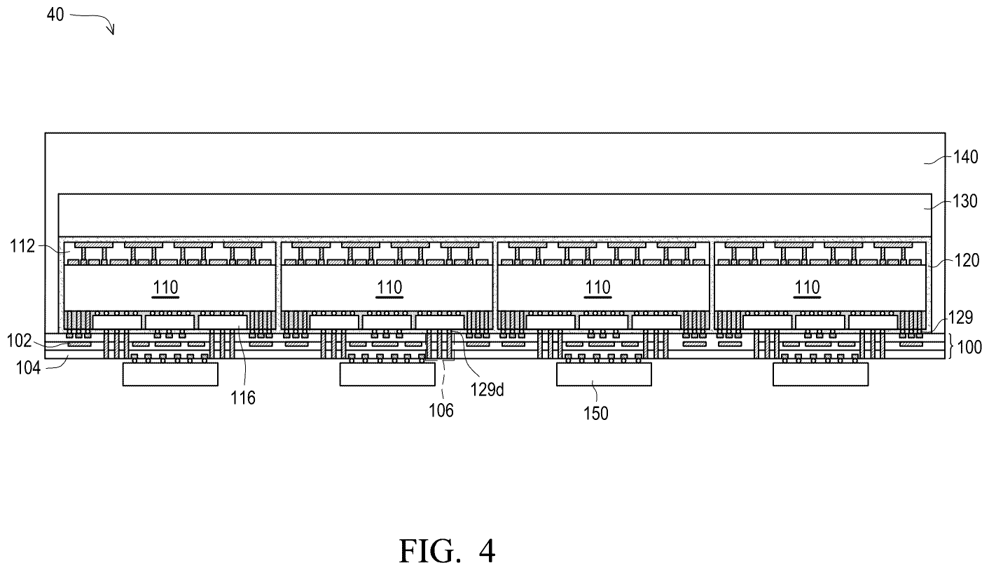

The components and parts in FIG. 4 correspond to those in the embodiments shown in FIGS. 1A to 1E, with the same or similar reference numerals representing the same or similar elements. Descriptions of identical technical content are omitted. For omitted portions, please refer to the previous embodiments, which are not repeated here.

Referring to FIG. 4, the main difference between packaging structure 40 and packaging structure 10 is that the radome 140 of packaging structure 40 is disposed on the superstrate 130 and also extends to the sidewalls of the superstrate 130 and the sidewalls of the first encapsulation layer 120. This results in the projected area of the superstrate 130 on the substrate 100 being greater than the projected area of the superstrate 130 on the substrate 100.

In the embodiments shown in FIGS. 2A and 3, the radome 140 may also extend to the sidewalls of the superstrate 130 and the first encapsulation layer 120, without limiting the scope of the invention.

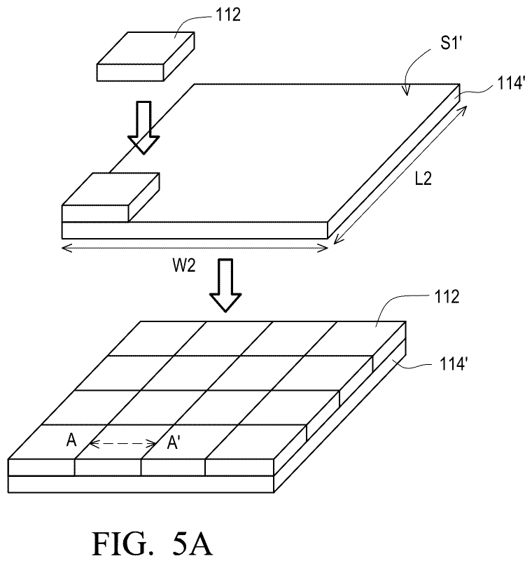

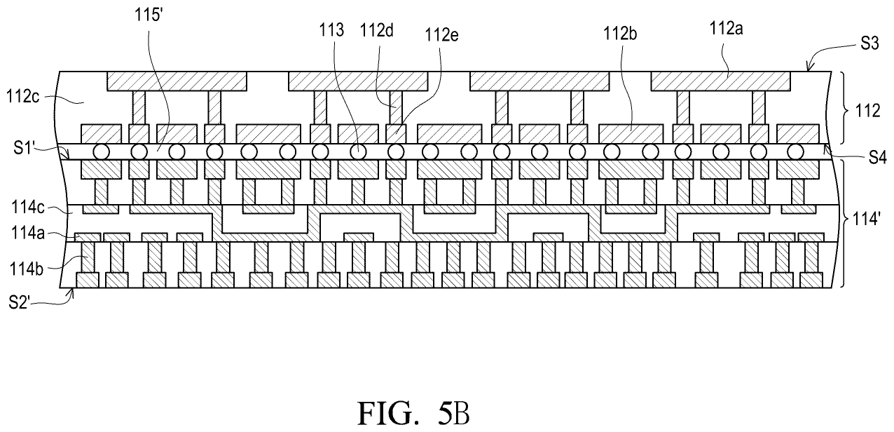

FIG. 5A shows only the relative position between the circuit substrate 114′ and the antenna structure 112, omitting related details. The components and parts in FIGS. 5A to 5B, FIG. 6, FIG. 7, and FIG. 8 correspond to those in the embodiments shown in FIGS. 1A to 1E, with the same or similar reference numerals representing the same or similar elements. Descriptions of identical technical content are omitted. For omitted portions, please refer to the previous embodiments, which are not repeated here.

Referring to FIGS. 5A and 5B, a circuit substrate 114′ and an antenna structure 112 are provided. For example, the circuit substrate 114′ may be a high-density interconnect (HDI) printed circuit board, which can be formed through build-up processes, lamination processes, drilling processes, electroplating processes, or the like. In some embodiments, the circuit substrate 114′ has a first surface S1′ and a second surface S2′ opposite to the first surface S1′. The circuit substrate 114′ may include a plurality of conductive layers 114a and a plurality of vias 114b located in an insulating layer 114c, where the plurality of vias 114b are disposed between adjacent conductive layers 114a in the vertical direction to electrically connect the adjacent conductive layers 114a. The circuit substrate 114′ may include signal transmission wiring and grounding wiring depending on the layout design. In some embodiments, the length L2 and width W2 of the circuit substrate 114′ may range from 200 mm to 300 mm.

The antenna structure 112 may include an antenna layer 112a, a ground layer 112b, a dielectric layer 112c, a vertical connector 112d, and a contact point 112e, and it may be pre-formed on a carrier (not shown) through deposition processes, photolithography processes, etching processes, or the like. In some embodiments, the dielectric layer 112c (or the antenna structure 112) has a third surface S3 and a fourth surface S4 opposite to the third surface S3. The antenna layer 112a is located on the third surface S3, the ground layer 112b and the contact point 112e are located on the fourth surface S4, and the vertical connector 112d connects the antenna layer 112a to the contact point 112e.

Referring again to FIGS. 5A and 5B, a plurality of antenna structures 112 are mounted on the first surface S1′ of the circuit substrate 114′. For example, a conductive connector 113 may be formed on the fourth surface S4 of the antenna structure 112 (or on the ground layer 112b and the contact point 112e). The antenna structure 112 is then bonded to the exposed conductive layer 114a on the first surface S1′ of the circuit substrate 114′ through the conductive connector 113 using flip-chip bonding techniques, and the carrier is removed. The above steps are repeated to mount a plurality of antenna structures 112 on the first surface S1′ of the circuit substrate 114′. In some embodiments, at least two antenna structures 112 are mounted on the circuit substrate 114′. FIG. 5A schematically illustrates 16 antenna structures 112 mounted on the circuit substrate 114′, but this is not limiting to the invention, and the number of antenna structures 112 mounted on the circuit substrate 114′ may be adjusted according to actual needs.

In some embodiments, a filling layer 115′ may be formed in the gap between the antenna structure 112 and the circuit substrate 114′ to laterally encapsulate the conductive connection 113.

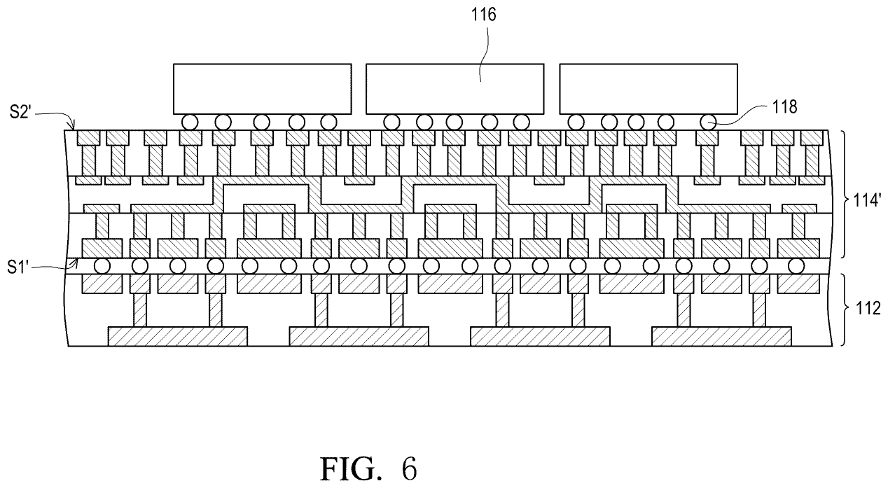

Please refer to FIG. 6, where the first chip 116 is mounted on the second surface S2′ of the circuit substrate 114′. For example, the structure of FIG. 5B may be flipped upside down so that the second surface S2′ of the circuit substrate 114′ faces upward. Then, the first chip 116 may be bonded to the exposed wiring layer 114a on the second surface S2′ of the circuit substrate 114′ through flip-chip bonding technology. In some embodiments, the first chip 116 may be electrically connected to the circuit substrate 114′ via conductive connections 118.

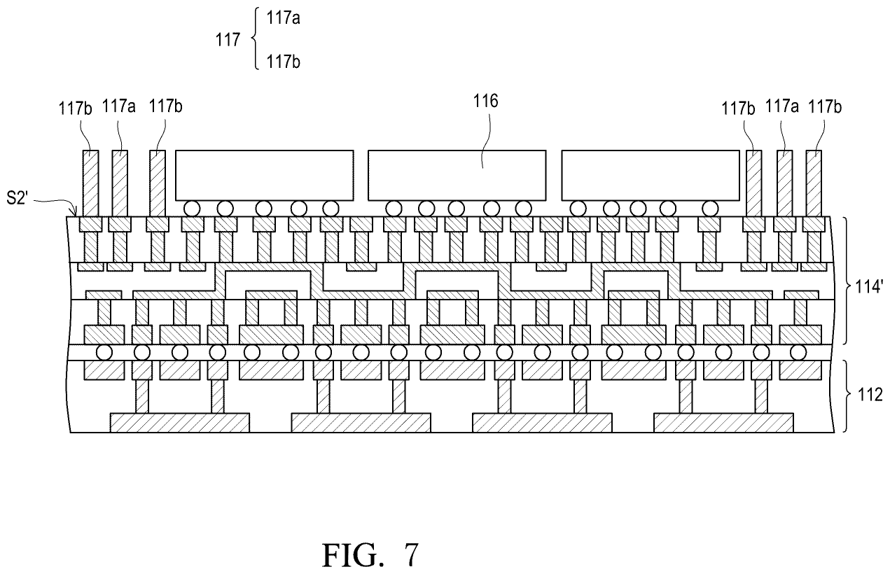

Please refer to FIG. 7, where conductive posts 117 are formed on the second surface S2′ of the circuit substrate 114′. For example, a photoresist layer (not shown) may first be formed on the second surface S2′ of the circuit substrate 114′, which has multiple openings to expose part of the wiring layer 114a of the circuit substrate 114′. Then, conductive material may be filled into these openings through an electroplating process or other suitable means to form the conductive posts 117, followed by removing the photoresist layer. In some embodiments, the conductive posts 117 may be arranged on both sides of the first chip 116, but the invention is not limited to this. In some embodiments, the conductive posts 117 may be arranged to surround the first chip 116.

In some embodiments, the conductive posts 117 may include conductive posts 117a for signal transmission and conductive posts 117b for grounding, according to the wiring design. In some embodiments, the grounding conductive posts 117b may surround the signal transmission conductive posts 117a to reduce noise interference and enhance signal integrity.

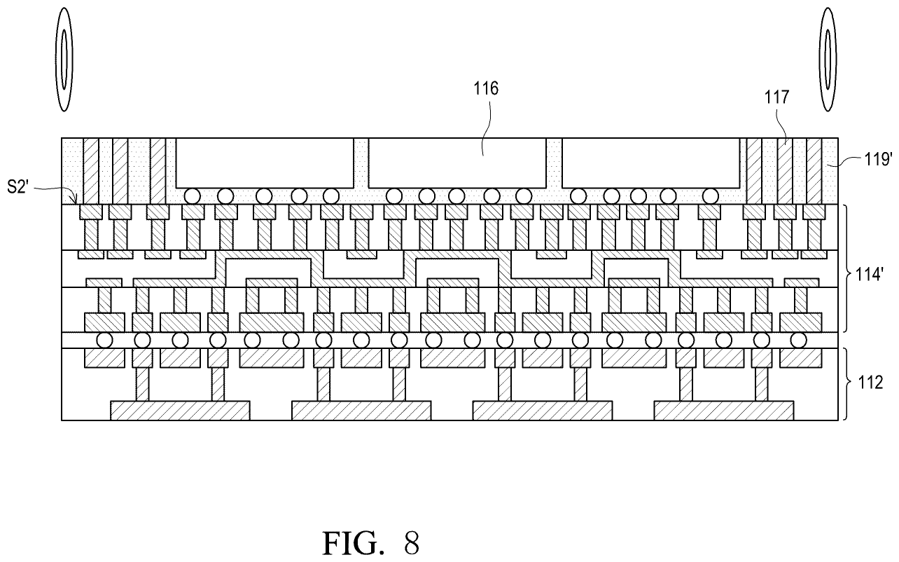

Please refer to FIG. 8, where a second encapsulation layer 119′ is formed on the second surface S2′ of the circuit substrate 114′. For example, a filling material layer (not shown) may be formed on the second surface S2′ of the circuit substrate 114′, the top surface and sidewalls of the first chip 116, and the top surface and sidewalls of the conductive posts 117 to encapsulate them. Then, a planarization process (such as chemical mechanical polishing or a similar process) may be carried out to remove part of the filling material layer until the surface of the first chip 116 (also referred to as the backside of the first chip 116) and the surface of the conductive posts 117 are exposed, thereby forming the second encapsulation layer 119′.

Then, a singulation process is performed to form an array of antenna module assemblies 110 (as shown in FIG. 1B), which include the antenna structure 112, the filling layer 115 (formed from the singulation of filling layer 115′), the circuit structure 114 (formed from the singulation of circuit substrate 114′), the first chip 116, the conductive posts 117, and the second encapsulation layer 119 (formed from the singulation of second encapsulation layer 119′). The sidewalls of the antenna structure 112, the circuit structure 114, and the second encapsulation layer 119 are substantially flush.

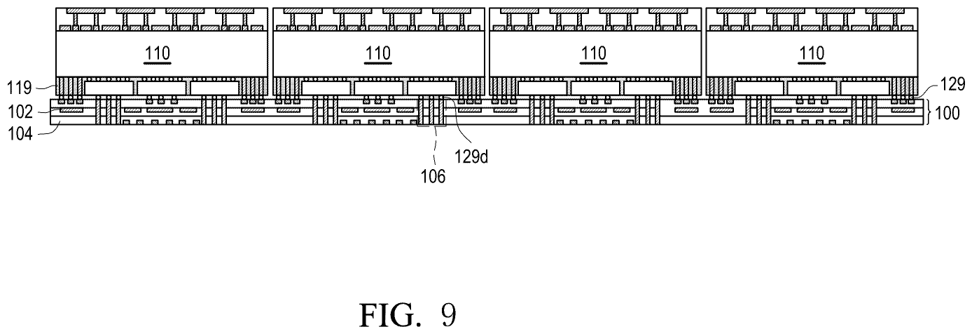

FIGS. 9 to 11 are cross-sectional schematic diagrams of the manufacturing process of a packaging structure according to an embodiment of the present invention. The component numbers and part of the content of the embodiment in FIGS. 9 to 11 continue from the embodiment in FIGS. 1A to 1E, where the same or similar numbers are used to represent the same or similar components, and descriptions of the same technical content are omitted. For details of the omitted descriptions, please refer to the foregoing embodiments, which will not be repeated here.

Please refer to FIG. 9, where an array of antenna module assemblies 110 are mounted on the substrate 100. The antenna module assembly 110 may be formed by the process described in FIGS. 5A to 8, and the substrate 100 may include alternating stacked conductive layers 102 and insulating layers 104, as well as heat dissipation structures 106. For example, conductive connectors 129 may be formed on the bottom surface of the antenna module assembly 110 (i.e., the side close to the second encapsulation layer 119), and the antenna module assembly 110 may be connected to the substrate 100 through the conductive connectors 129.

In some embodiments, an array of antenna module assemblies 110 of the same or different frequency bands may be installed on substrate 100 according to the requirements of the supported frequency bands (as in the embodiment of FIG. 1A or FIG. 4). Since the array of antenna module assemblies 110 is pre-formed and then mounted on the substrate 100, the type of antenna module assembly can be flexibly adjusted to meet the needs of different packaging structures. As a result, packaging structures supporting single or multiple frequency bands can be easily manufactured.

In some embodiments, the conductive connectors 129 may connect the conductive posts 117 of the antenna module assembly 110 to the conductive layer 104 of the substrate 100 for signal transmission. In some embodiments, some of the conductive connectors 129 are dummy conductive connectors 129d, which may be connected between the first chip 116 and the heat dissipation structures 106 of the substrate 100 to assist in dissipating the heat from the first chip 116 to the external environment.

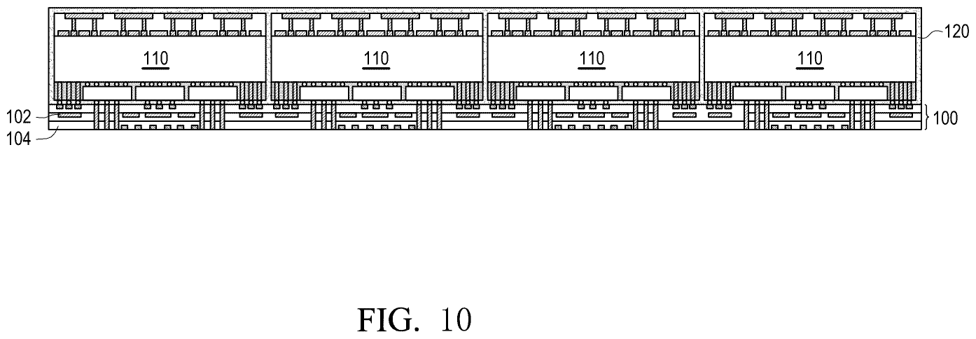

Please refer to FIG. 10, where a first encapsulation layer 120 is formed on the substrate 100 and the array of antenna module assemblies 110 to encapsulate each antenna module assembly 110. The first encapsulation layer 120 may fill the gaps between adjacent antenna module assemblies 110, as well as the gaps between the array of antenna module assemblies 110 and the substrate 100, and encapsulate the conductive connectors 129. The first encapsulation layer 120 may also be disposed on the top surface (i.e., the side close to the antenna layer 112a) and the sidewalls of each antenna module assembly 110.

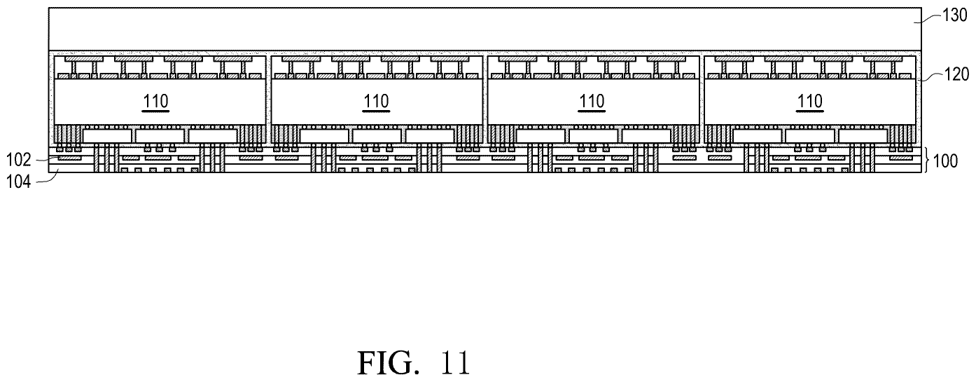

Please refer to FIG. 11, where a superstrate 130 is formed on the first encapsulation layer 120, and the projection area of the superstrate 130 on the substrate 100 is larger than the projection area of each antenna module assembly 110 on the substrate 100. For example, dielectric material may be deposited on the first encapsulation layer 120 through a chemical vapor deposition process, spin coating process, molding process, or other suitable processes to form the superstrate 130.

In some embodiments, where the superstrate 130 also includes a coupling layer 132 and a repetitive pattern 134 (as in the embodiment of FIG. 2A), the coupling layer 132 may first be formed on the first encapsulation layer 120, and then dielectric material for the superstrate 130 may be formed on the coupling layer 132. Afterward, the repetitive pattern 134 may be formed on the dielectric material.

In some embodiments, the steps of forming the coupling layer 132 and the repetitive pattern 134 may include forming a coupling material layer/repetitive pattern material layer through chemical vapor deposition, physical vapor deposition, electroplating, electroless plating, or other suitable processes, followed by patterning the coupling material layer/repetitive pattern material layer through lithography and etching processes to form the coupling layer 132 and the repetitive pattern 134.

Please refer to FIG. 1A, where a radome 140 is formed on the superstrate 130. The radome 140 may be formed through a chemical vapor deposition process, spin coating process, molding process, or other suitable processes. In some embodiments, the radome 140 may extend to the sidewalls of the superstrate 130 and the first encapsulation layer 120 (as shown in FIG. 4). That is, the projection area of the radome 140 on the substrate 100 may be larger than or equal to the projection area of the superstrate 130 on the substrate 100.

Then, a second chip 150 may be mounted on the bottom surface 100b of the substrate 100. For example, the second chip 150 may be electrically connected to the exposed conductive layer 104 on the bottom surface 100b of the substrate 100 through conductive connectors 159. In some embodiments, an underfill layer (not shown) may be formed in the gap between the second chip 150 and the substrate 100 to laterally encapsulate the conductive connectors 159.

Based on the above, the packaging structure 10 may be substantially completed.

In some embodiments, the packaging structure is formed by mounting an array of small-area antenna module assemblies onto a large-area substrate. The array of antenna module assemblies may be configured to meet particular design requirements, enabling the packaging structure to support multiple frequency bands in an adaptable manner.

It will be apparent to those skilled in the art that various modifications and variations can be made to the structure of the present invention without departing from the scope or spirit of the disclosure. In view of the foregoing, it is intended that the present disclosure cover modifications and variations of this invention provided they fall within the scope of the following claims and their equivalents.

What is claimed is:

1. A packaging structure comprising:
a substrate;
an array of antenna module assemblies on the substrate;
a first encapsulation layer on the array of antenna module assemblies, encapsulating each of the array of antenna module assemblies;
a superstrate on the first encapsulation layer, wherein the projected area of the superstrate on the substrate is larger than the projected area of each of the array of antenna module assemblies on the substrate; and
a radome on the superstrate.

2. The packaging structure of claim 1, wherein each of the array of antenna module assemblies comprises:
a circuit structure having a first surface and a second surface opposite the first surface;
an antenna structure on the first surface of the circuit structure; and
a first chip disposed on the second surface of the circuit structure, wherein the first chip of each of the array of antenna module assemblies is located between the antenna structure and the substrate.

3. The packaging structure of claim 2, wherein the antenna structure comprises:
a dielectric layer having a third surface and a fourth surface opposite the third surface;
an antenna layer on the third surface of the dielectric layer, wherein the antenna layer comprises antenna patterns arranged in at least 4 rows and 4 columns; and
a ground layer on the fourth surface of the dielectric layer, wherein the fourth surface of the dielectric layer faces the first surface of the circuit structure.

4. The packaging structure of claim 2, wherein each of the array of antenna module assemblies further comprises:
a second encapsulation layer laterally encapsulating the first chip; and
conductive pillars in the second encapsulation layer and electrically connected to the circuit structure.

5. The packaging structure of claim 4, wherein sidewalls of the antenna structure, the circuit structure, and the second encapsulation layer are aligned such that a variation in height between the sidewalls is within a predetermined tolerance.

6. The packaging structure of claim 1, wherein a length or a width of each of the array of antenna module assemblies is between 10 mm and 30 mm.

7. The packaging structure of claim 1, wherein portions of the first encapsulation layer are between the array of antenna module assemblies and the substrate.

8. The packaging structure of claim 1, wherein portions of the first encapsulation layer are in gaps between the array of antenna module assemblies.

9. The packaging structure of claim 1, wherein the superstrate comprises dielectric materials with a dielectric constant between 2 and 10.

10. The packaging structure of claim 1, wherein a lower surface of the superstrate comprises a coupling layer, facing the array of antenna module assemblies.

11. The packaging structure of claim 10, wherein a projection of the coupling layer on the substrate overlaps with a projection of gaps between adjacent ones of the array of antenna module assemblies on the substrate.

12. The packaging structure of claim 10, wherein a pattern of the coupling layer is complementary to a pattern of the antenna layer of the array of antenna module assemblies.

13. The packaging structure of claim 10, wherein an upper surface of the superstrate comprises a repeating pattern as a frequency-selective surface, wherein the upper surface of the superstrate is opposite the lower surface.

14. The packaging structure of claim 1, wherein the radome extends over sidewalls of the superstrate.

15. The packaging structure of claim 1, wherein the array of antenna module assemblies comprises a first antenna array module and a second antenna array module, a frequency band supported by the first antenna array module being different from a frequency band supported by the second antenna array module, wherein the supported frequency bands are based on signal wavelengths transmitted or received by the respective antenna layers of the first and second antenna array modules.

16. A method of manufacturing a packaging structure, comprising:
mounting an array of antenna module assemblies on a substrate;
forming a first encapsulation layer on the array of antenna module assemblies to encapsulate each antenna module assembly;
forming a superstrate on the first encapsulation layer, wherein a projected area of the superstrate on the substrate is larger than a projected area of each of the array of antenna module assemblies on the substrate; and
forming a radome on the superstrate.

17. The method of manufacturing a packaging structure of claim 16, wherein a method of forming one of the array of antenna module assemblies comprises:
providing a circuit substrate, wherein the circuit substrate has a first surface and a second surface opposite the first surface;
mounting a plurality of antenna structures on the first surface of the circuit substrate;
mounting a first chip on the second surface of the circuit substrate; and
performing a singulation process.

18. The method of manufacturing a packaging structure of claim 17, wherein the method of forming one of the array of antenna module assemblies further comprises:
forming conductive pillars on the second surface of the circuit substrate; and
forming a second encapsulation layer on the second surface of the circuit substrate, laterally encapsulating the first chip and the conductive pillars.

19. The method of manufacturing a packaging structure of claim 16, wherein the array of antenna module assemblies are joined to the substrate through conductive connectors.

20. The method of manufacturing a packaging structure of claim 16, wherein steps of forming the superstrate on the first encapsulation layer comprises:
forming a coupling layer on the first encapsulation layer;
forming a dielectric material layer on the coupling layer; and
forming a repeating pattern on the dielectric material layer.
